(19) United States
(12) Patent Application Publication
(10) Pub. No.: US 2025/0100468 A1
(43) Pub. Date: Mar. 27, 2025

(54) WIRE HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Hideaki ITO, Osaka (JP); Daichi ASHIDA, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/727,724

(22) PCT Filed: Jan. 27, 2023
(86) PCT No.: PCT/JP2023/002627

§ 371 Date: Jul. 10, 2024

(30) Foreign Application Priority Data
Jan. 31, 2022 (JP) 2022-012782

(51) Int. Cl. B60R 16/02; H02G 3/04

(52) U.S. Cl. CPC B60R 16/0215; H02G 3/04

(57) ABSTRACT

A wire harness includes: an apparatus connector connected to a connector of an apparatus; a first harness connector connected to a connector of a first counterpart wire harness; a second harness connector connected to a connector of a second counterpart wire harness; a first apparatus wiring connecting the apparatus connector and the first harness connector; a second apparatus wiring connecting the apparatus connector and the second harness connector; and a flat base member holding the first apparatus wiring and the second apparatus wiring.

### TECHNICAL FIELD

The present disclosure relates to a wire harness.

### BACKGROUND ART

Patent Document 1 discloses an interconnection box electrically interconnecting an instrument panel harness, an engine room harness, a door harness, and a floor harness.

### PRIOR ART DOCUMENTS

### Patent Document(s)

Patent Document 1: Japanese Patent Application Laid-Open No. 2007-202352

### SUMMARY

### Problem to be Solved by the Invention

Desired are downsizing of an apparatus to which a wire harness is connected and reduction of thickness of the wire harness.

Accordingly, an object is to provide a technique capable of downsizing an apparatus to which a wire harness is connected and reducing a thickness of the wire harness.

### Means to Solve the Problem

A wire harness according to the present disclosure is a wire harness, including: an apparatus connector connected to a connector of an apparatus; a first harness connector connected to a connector of a first counterpart wire harness; a second harness connector connected to a connector of a second counterpart wire harness; a first apparatus wiring connecting the apparatus connector and the first harness connector; a second apparatus wiring connecting the apparatus connector and the second harness connector; and a flat base member holding the first apparatus wiring and the second apparatus wiring.

### Effects of the Invention

According to the present disclosure, an apparatus to which a wire harness is connected can be downsized, and a thickness of the harness can be reduced.

### BRIEF DESCRIPTION OF DRAWINGS

FIG. 1 is an explanation view illustrating a wiring system including a wire harness in a vehicle.

FIG. 2 is a plan view illustrating a wire harness according to an embodiment 1.

FIG. 3 is a cross-sectional view along a III-III line in FIG. 2.

FIG. 4 is a perspective view illustrating a state where the wire harness is disposed in a vehicle.

FIG. 5 is a perspective view illustrating a state where a wire harness according to an embodiment 2 is disposed in a vehicle.

FIG. 6 is a plan view illustrating the wire harness according to the embodiment 2.

FIG. 7 is an exploded plan view illustrating the wire harness according to the embodiment 2.

FIG. 8 is a cross-sectional view along a VIII-VIII line in FIG. 6.

FIG. 9 is a cross-sectional view illustrating a wire harness according to a first modification example.

FIG. 10 is an exploded plan view illustrating the wire harness according to the first modification example.

FIG. 11 is a plan view illustrating a wire harness according to a second modification example.

FIG. 12 is an exploded plan view illustrating a wire harness according to a third modification example.

FIG. 13 is a perspective view illustrating a wire harness according to a fourth modification example.

FIG. 14 is an exploded perspective view illustrating the wire harness according to the fourth modification example.

FIG. 15 is a cross-sectional view illustrating a wire harness according to a fifth modification example.

### DESCRIPTION OF EMBODIMENT(S)

### Description of Embodiment of Present Disclosure

Embodiments of the present disclosure are listed and described firstly.

A wire harness of the present disclosure has a configuration described hereinafter.

(1) A wire harness includes: an apparatus connector connected to a connector of an apparatus; a first harness connector connected to a connector of a first counterpart wire harness; a second harness connector connected to a connector of a second counterpart wire harness; a first apparatus wiring connecting the apparatus connector and the first harness connector; a second apparatus wiring connecting the apparatus connector and the second harness connector; and a flat base member holding the first apparatus wiring and the second apparatus wiring. The first counterpart wire harness and the second counterpart wire harness are collectively connected to the apparatus via the apparatus connector. Accordingly, the number of connectors of the apparatus can be reduced compared with a case where the first counterpart wire harness and the second counterpart wire harness are individually connected to the apparatus, and the apparatus to which the wire harness is connected can be downsized. The first apparatus wiring and the second apparatus wiring are held by a flat base member, thus an intermediate wiring part is flat, and a thickness of the wire harness can be reduced.

(2) In the wire harness according to (1), a distance from the first harness connector to the second harness connector may be smaller than any of a distance from the apparatus connector to the first harness connector and a distance from the apparatus connector to the second harness connector. Accordingly, the first harness connector and the second harness connector can be disposed close to each other, and an operation of connecting the first counterpart wire harness and the second counterpart wire harness to the wire harness is easily performed. The first counterpart wire harness and the second counterpart wire harness can be simply connected to a distant apparatus via the wire harness.

(3) In the wire harness according to (2), it is applicable that the base member includes a first band-like part and a second band-like part having a larger length than the first band-like part, a base end portion of the second band-like part extends from an intermediate portion of the first band-like part in a direction intersecting with the first band-like part, the first harness connector is provided to one end portion of the first band-like part, the second harness connector is provided to another end portion of the first band-like part, and the apparatus connector is provided to a tip end portion of the second band-like part, the first apparatus wiring extends from the one end portion of the first band-like part toward the tip end portion of the second band-like part, and the second apparatus wiring extends from the another end portion of the first band-like part toward the tip end portion of the second band-like part. Accordingly, the first counterpart wire harness and the second counterpart wire harness extending from sides opposite to each other can be simply connected to the wire harness.

(4) In the wire harness according to any one of (1) to (3), a wiring connecting the first harness connector and the second harness connector may not be included. Accordingly, the wire harness does not connect the first counterpart wire harness and the second counterpart wire harness, thus the wire harness is simplified.

(5) In the wire harness according to any one of (1) to (4), a length of each of the first apparatus wiring and the second apparatus wiring may be equal to or smaller than one meter. Accordingly, the wire harness can connect the apparatus and the counterpart wire harness in a narrow area in a vehicle.

(6) In the wire harness according to any one of (1) to (5), it is applicable that an arrangement area in a vehicle is a rear part area, the first harness connector is a floor harness connector, and the second harness connector is a rear harness connector. Accordingly, the floor harness and the rear harness are connected to the apparatus via the wire harness in the rear part area in the vehicle.

### Detailed Description of Embodiment of Present Disclosure

Specific examples of a wire harness of the present disclosure are described hereinafter with reference to the drawings. The present disclosure is not limited to these examples, but is indicated by claims, and it is intended that meanings equivalent to claims and all modifications within a scope of claims are included.

### Embodiment 1

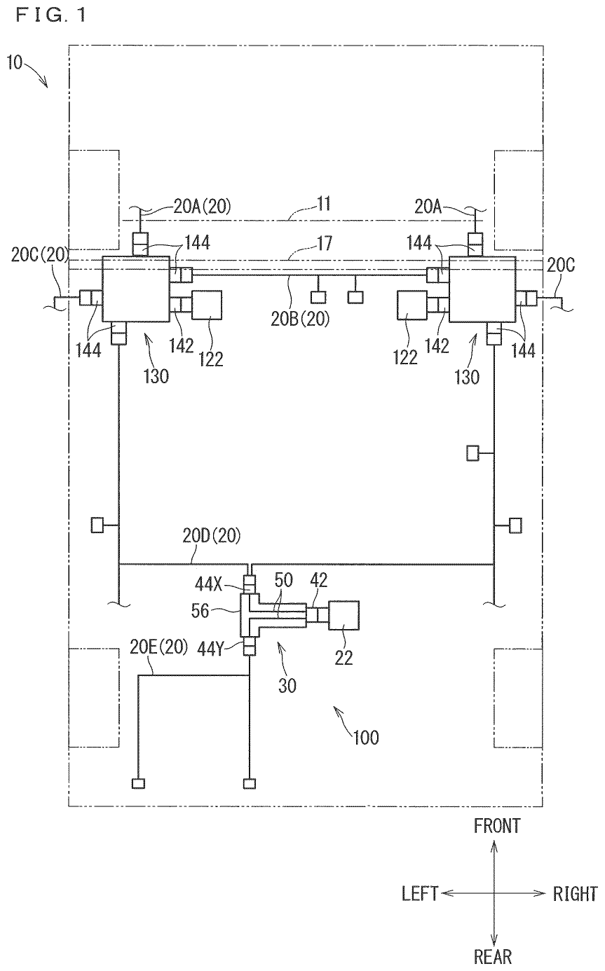

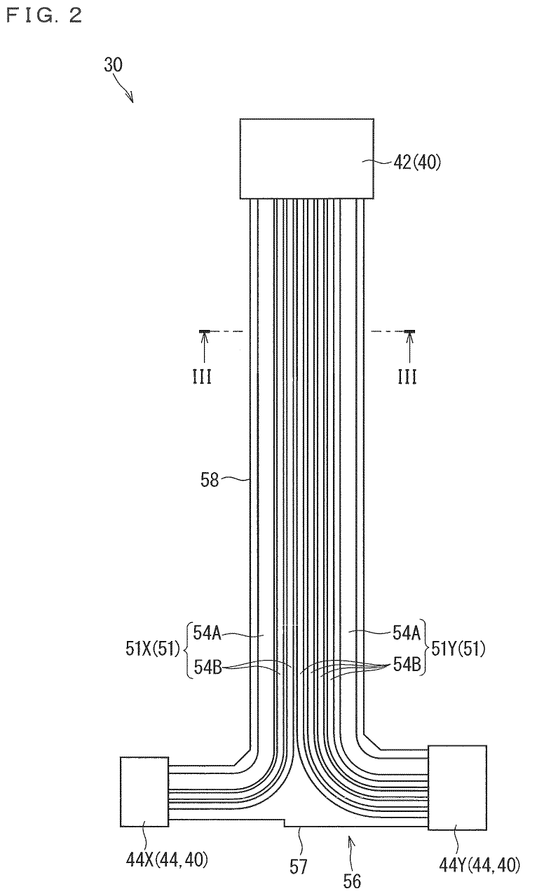

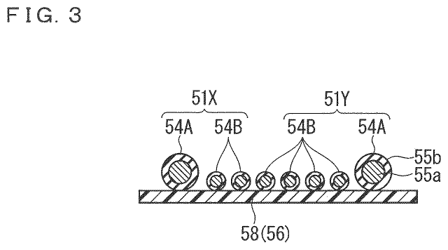

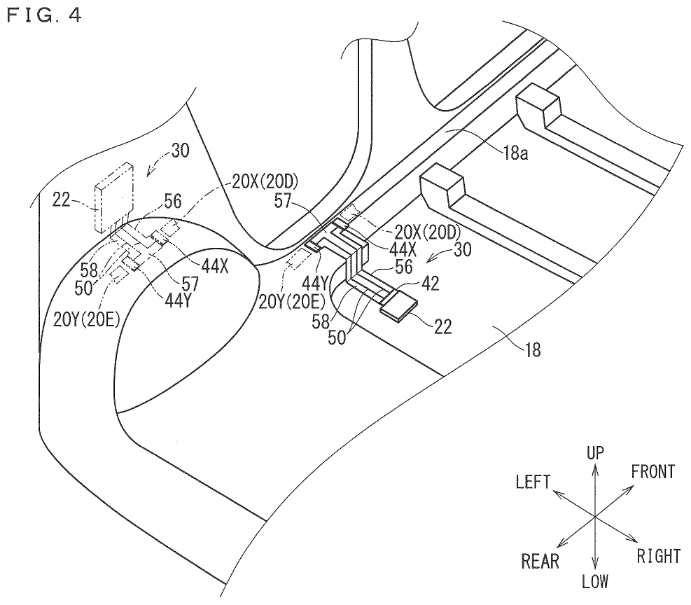

A wire harness according to an embodiment 1 is described hereinafter. FIG. 1 is an explanation view illustrating a wiring system 100 including a wire harness 30 in a vehicle 10. FIG. 2 is a plan view illustrating a wire harness 30 according to the embodiment 1. FIG. 3 is a cross-sectional view along a III-III line in FIG. 2. FIG. 4 is a perspective view illustrating a state where the wire harness 30 is disposed in the vehicle 10.

The wire harness 30 is disposed in the vehicle 10, for example. A plurality of counterpart wire harnesses 20 and an apparatus 22 are also disposed in the vehicle 10. The wire harness 30 connects the plurality of counterpart wire harnesses 20 to the apparatus 22. The wire harness 30 and the plurality of counterpart wire harnesses 20 are incorporated into the wiring system 100 in the vehicle 10. The wiring system 100 and an arrangement area of the wire harness 30 in the vehicle 10 are described firstly.

### <Wiring System 100>

The wiring system 100 includes the wire harness 30 and the plurality of counterpart wire harnesses 20. The plurality of counterpart wire harnesses 20 are disposed in areas different from each other in the vehicle 10. The wire harness 30 intervenes between the plurality of counterpart wire harnesses 20 and the apparatus 22 to connect each of the plurality of counterpart wire harnesses 20 to the apparatus 22.

The arrangement area of the wire harness 30 in the vehicle 10 is an area corresponding to arrangement areas of the plurality of counterpart wire harnesses 20. When the intervention of the wire harness 30 between the plurality of counterpart wire harnesses 20 is considered, the arrangement area of the wire harness 30 is preferably an area close to boundaries of a plurality of areas where the plurality of counterpart wire harnesses 20 are disposed, respectively. The arrangement area of the wire harness 30 is located between areas where the plurality of counterpart wire harnesses 20 are disposed, for example. Assumed as the counterpart wire harness 20 are an engine room harness 20A, an instrument panel harness 20B, a door harness 20C, a floor harness 20D, a rear harness 20E, for example. The engine room harness 20A is disposed in an engine room. The instrument panel harness 20B is disposed to extend along an instrument panel reinforcement 17. The door harness 20C is disposed in a door. The floor harness 20D is disposed along a floor panel 18. The rear harness 20E is disposed in an area on a back side of the floor harness 20D. The rear harness 20E is connected to a load of a rear lamp or a rear wiper, for example.

In the present disclosure, a term of engine room is an expediential address term of a front room located in front of a vehicle interior, thus an engine needs not necessarily be disposed in the engine room. In the similar manner, in the present disclosure, a term of the engine room harness 20A is an expediential address term of the counterpart wire harness 20 disposed in the front room located in front of the vehicle interior.

The wiring system 100 further includes a wire harness 130 disposed in an area different from the wire harness 30. The wire harness 130 intervenes between the plurality of counterpart wire harnesses 20 and an apparatus 122 to connect each of the plurality of counterpart wire harnesses 20 to the apparatus 122. The wire harness 30 is described in the present embodiment, and the wire harness 130 is described in an embodiment 2.

Herein, the arrangement area of the wire harness 30 in the vehicle 10 is the rear part area. Particularly, the arrangement area is an area in the rear part area such as a position close to a rear sheet (for example, a lower side or a back side of a rear sheet) or a rear luggage, for example. FIG. 4 illustrates a case where the wire harness 30 is disposed in a position close to the rear sheet by a solid line, and illustrates a case where the wire harness 30 is disposed in the rear luggage by a dash-double-dot line. When the arrangement area of the wire harness 30 is the rear part area, the floor harness 20D and the rear harness 20E are assumed as the counterpart wire harnesses 20. A rocker part 18a, for example, is located in a side edge of the floor panel 18 in the vehicle. An end portion of the floor harness 20D connected to the wire harness 30 extends in a front-back direction of the vehicle along the rocker part 18a.

In the present disclosure, when the arrangement areas of the plurality of counterpart wire harnesses 20 such as the floor harness 20D and the rear harness 20E are separated in the front-back direction of the vehicle 10, the counterpart wire harness 20 disposed on a front side in the plurality of counterpart wire harnesses 20 is referred to as a front harness in some cases. The counterpart wire harness 20 disposed on a back side of the front harness in the plurality of counterpart wire harnesses 20 is referred to as a back harness in some cases.

The arrangement area of the wire harness 30 is an area to which a passenger cannot simply have access to in normal use of the vehicle 10, for example. The apparatus 22 is disposed in the same area as the arrangement area of the wire harness 30. The apparatus 22 is an electrical apparatus which is not operated by a passenger in normal use of the vehicle 10.

The apparatus 22 is an electrical control unit (ECU), for example. One central ECU and a plurality of zone ECUs may be provided in the vehicle 10. The zone ECU is provided for each zone sectioned into a plurality of areas in the vehicle 10. The zone ECU mainly controls the apparatus 22 located in the zone. The central ECU achieves control of summing up the plurality of zone ECUs and collaborating in the whole vehicle 10. The apparatus 22 may be the zone ECU, for example. In this case, the apparatus 22 as the zone ECU controls a plurality of apparatuses as connection destinations of the floor harness 20D of the rear harness 20E, for example.

The apparatus 22 as the ECU may be a general ECU other than the zone ECU. The apparatus 22 needs not be the ECU, but may be a junction block (also referred to as an electrical junction box), for example.

### <Wire Harness 30>

The wire harness 30 includes plural types of connector 40, a plurality of wirings 50, and a base member 56.

The plural types of connector 40 are connected to connection destinations different from each other, respectively. The plural types of connector 40 include an apparatus connector 42 and a harness connector 44. The apparatus connector 42 is connected to the connector 40 of the apparatus 22. The harness connector 44 includes a first harness connector 44X and a second harness connector 44Y. The first harness connector 44X is connected to a connector of a first counterpart wire harness 20X. The second harness connector 44Y is connected to a connector of a second counterpart wire harness 20Y.

In the example illustrated in FIG. 2, each type of the connector 40 is one connector. That is to say, each of the apparatus connector 42, the first harness connector 44X, and the second harness connector 44Y is one connector. In the present disclosure, two or more connectors are considered one type of connector when the connection destination thereof is the same as each other. In other words, any number of connectors connected to the same apparatus 22 or the same counterpart wire harness 20 are considered one type of connector. From the other viewpoint, each of the plural types of connector 40 is made up of one or more connectors (referred to as a split connector in some cases hereinafter). Each connector may include a connector having the same structure. Herein, the connectors having the same structure are considered different types of connector when the connection destinations thereof are different from each other.

At least one of the plural types of connector 40 may include two or more split connectors. For example, the connector 40 having a largest number of electrodes (apparatus connector 42, for example) in the plural types of connector 40 may include two or more split connectors. Accordingly, the connector 40 having the largest number of electrodes in the plural types of connector 40 can be easily manufactured.

When the connector 40 includes the plurality of split connectors, it is preferable that the plural types of connector 40 are four or more types of connector, and the number of the split connectors is equal to or smaller than N. Herein, N is a number obtained by subtracting two from the number of types of the plural types of connector 40 in the wire harness 30. Accordingly, the number of groups of connectors to be fitted can be reduced compared with a case where one type of connector 40 is connected to the connection destination of the other type of connector 40. Specifically, herein, the connectors 40 in the wire harness 30 are three types of connector, that is the apparatus connector 42, the first harness connector 44X, and the second harness connector 44Y. Thus, the connector 40 in the wire harness 30 does not preferably include the plurality of split connectors.

For example, each connector 40 includes a connector terminal and a connector housing. The connector terminal is electrically connected to an end portion of a wiring 50. When the connector 40 and the counterpart connector are connected to each other, the wiring 50 is electrically connected to the counterpart conductor via the connector terminal. The connector housing has insulation properties. The connector housing keeps the connector terminal in a predetermined arrangement.

The plurality of wirings 50 include a plurality of apparatus wirings 51. The plurality of apparatus wirings 51 include a first apparatus wiring 51X and a second apparatus wiring 51Y. The first apparatus wiring 51X connects the apparatus connector 42 and the first harness connector 44X. The second apparatus wiring 51Y connects the apparatus connector 42 and the second harness connector 44Y.

Only one apparatus connector 42 is provided herein. The plurality of apparatus connector 42 may also be provided. The harness connector 44 includes only two connectors, that is the first harness connector 44X and the second harness connector 44Y. Three or more harness connectors 44 may also be provided. The plurality of wirings 50 includes only the plurality of apparatus wirings 51. The plurality of wirings 50 may also include a wiring different from the apparatus wiring 51. The plurality of apparatus wirings 51 include only the first apparatus wiring 51X and the second apparatus wiring 51Y. The plurality of apparatus wirings 51 may also include an apparatus wiring different from the first apparatus wiring 51X and the second apparatus wiring 51Y.

Herein, the first counterpart wire harness 20X is the floor harness 20D, and the second counterpart wire harness 20Y is the rear harness 20E. The first harness connector 44X is a connector for the floor harness 20D, and the second harness connector 44Y is a connector for the rear harness 20E. The first apparatus wiring 51X connects the apparatus connector 42 and the floor harness connector 44X. The second apparatus wiring 51Y connects the apparatus connector 42 and the rear harness connector 44Y.

Herein, an electrical wire 54 is provided as the wiring 50. The electrical wire 54 is a covering electrical wire. The covering electrical wire includes a core wire 55a and a covering layer 55b covering the core wire 55a. The covering electrical wire may include the covering layer 55b which is extrusion molded. The covering electrical wire may be an enamel electrical wire. The covering layer 55b is provided separately from the base member 56. However, a flexible flat cable (FFC) or a flexible printed circuit (FPC) may be provided in the wire harness 30. In this case, the covering layer may double as the base member. That is to say, a plurality of bare conductors as wirings may be collectively covered by the covering layer as the base member.

The base member 56 is a flat member. The base member 56 holds the first apparatus wiring 51X and the second apparatus wiring 51Y. The base member 56 may be a member made of resin or metal, or may also be a composite member including a portion made of resin and a portion made of metal. The base member 56 may be a flexible sheet member. The sheet member may be the sheet including a fiber material such as a non-woven cloth, for example. The sheet member may be the sheet having a filled cross-sectional surface. The sheet member has flexibility so as to be able to follow bending of the electrical wire 54.

The plurality of electrical wires 54 are arranged side by side on a main surface of the base member 56. Each electrical wire 54 is fixed to the base member 56, thus a parallel state is maintained. A fixing state of the electrical wire 54 and the base member 56 is not particularly limited, but can be appropriately set. The electrical wire 54 and the base member 56 may be fixed by fusion, for example. In this case, resin included in at least one of the covering of the electrical wire 54 and/or the main surface of the base member 56 is melted, and bonded and fixed to a surface of the counterpart member. The electrical wire 54 and the base member 56 may be attached by an adhesive material or a gluing material, for example.

In the wire harness 30, the electrical wires 54 are disposed so as not to intersect with each other on the base member 56. Suppressed accordingly is increase of a thickness of the wire harness 30. However, in the wire harness 30, an intersection part where the electrical wires 54 intersect with each other on the base member 56 may also be provided.

The base member 56 includes a first band-like part 57 and a second band-like part 58. A base end portion of the second band-like part 58 extends from an intermediate portion of the first band-like part 57 in a direction intersecting with the first band-like part 57. An intersection part where the first band-like part 57 and the second band-like part 58 intersect with each other is a branch part. The second band-like part 58 has a larger length than the first band-like part 57. The base member 56 is formed into a T-like shape.

The first harness connector 44X is provided to one end portion of the first band-like part 57. The second harness connector 44Y is provided to the other end portion of the first band-like part 57. The apparatus connector 42 is provided to a tip end portion of the second band-like part 58. The first apparatus wiring 51X extends from one end portion of the first band-like part 57 toward a tip end portion of the second band-like part 58. The second apparatus wiring 51Y extends from the other end portion of the first band-like part 57 toward the tip end portion of the second band-like part 58. The first apparatus wiring 51X and the second apparatus wiring 51Y extend from the tip end portion of the second band-like part 58 toward a base end portion of the second band-like part 58, and then branched to extend along the first band-like part 57 in directions opposite to each other.

As illustrated by a solid line in FIG. 4, when the wire harness 30 is disposed close to a rear sheet, it is applicable that the first band-like part 57 follows the rocker part 18a and the second band-like part 58 is disposed in a body part of the floor panel 18, for example. The apparatus connector 42 is connected to the apparatus 22 in a position close to the body part of the floor panel 18. The first harness connector 44X is connected to the floor harness 20D, and the second harness connector 44Y is connected to the rear harness 20E in a position close to the rocker part 18a. The rocker part 18a is normally located in a higher position than the body part of the floor panel 18. Thus, a position where the harness connector 44 is connected to the counterpart wire harness 20 and a position where the apparatus connector 42 is connected to the apparatus 22 are located away from each other in an up-down direction.

As illustrated by a dash-double-dot line in FIG. 4, when the wire harness 30 is disposed in a rear luggage, it is applicable that the first band-like part 57 follows an upper part of a portion constituting a rear wheel house and the second band-like part 58 and the apparatus 22 are disposed in a side panel, for example. The first harness connector 44X is connected to the floor harness 20D, and the second harness connector 44Y is connected to the rear harness 20E in a position close to the upper part of the portion constituting the rear wheel house. The apparatus connector 42 is connected to the apparatus 22 in the side panel. Thus, a position where the harness connector 44 is connected to the counterpart wire harness 20 and a position where the apparatus connector 42 is connected to the apparatus 22 are located away from each other in an up-down direction.

As illustrated in FIG. 4, the wire harness 30 may be disposed in the vehicle 10 while the base member 56 is bended in a thickness direction. A bending position and the number of bending are not particularly limited in the base member 56, but can be appropriately set. In the example illustrated by the solid line in FIG. 4, the wire harness 30 is disposed while the base member 56 is bended twice. Two bending positions are bended in directions opposite to each other. In the example illustrated by the dash-double-dot line in FIG. 4, the base member 56 is disposed while being bended once. The wire harness 30 may be disposed while the second band-like part 58 is bended. The position where the harness connector 44 is connected to the counterpart wire harness 20 and the position where the apparatus connector 42 is connected to the apparatus 22 are located away from each other in a horizontal direction (right-left direction in the example illustrated in FIG. 4).

A distance from the first harness connector 44X to the second harness connector 44Y is smaller than any of a distance from the apparatus connector 42 to the first harness connector 44X and a distance from the apparatus connector 42 to the second harness connector 44Y. Herein, the distance from the first harness connector 44X to the second harness connector 44Y is substantially equal to a length dimension of the first band-like part 57. The distance from the apparatus connector 42 to the first harness connector 44X is substantially equal to the distance from the apparatus connector 42 to the second harness connector 44Y. Each of the distance from the first harness connector 44X to the second harness connector 44Y, the distance from the apparatus connector 42 to the first harness connector 44X, and the distance from the apparatus connector 42 to the second harness connector 44Y is a distance in a state where the base member 56 is not bended in the thickness direction. Each of the distance from the first harness connector 44X to the second harness connector 44Y, the distance from the apparatus connector 42 to the first harness connector 44X, and the distance from the apparatus connector 42 to the second harness connector 44Y may be a distance while being disposed in the vehicle 10.

The wire harness 30 does not include a wiring connecting the first harness connector 44X and the second harness connector 44Y. The wire harness 30 does not include a wiring connecting the plurality of harness connectors 44. The wire harness 30 includes only the apparatus wiring 51 connecting each of the plurality of harness connectors 44 to the apparatus connector 42.

A length of each of the first apparatus wiring 51X and the second apparatus wiring 51Y is equal to or smaller than one meter. Herein, the plurality of electrical wires 54 have substantially the same length dimension. The length dimension of each electrical wire 54 is equal to or smaller than one meter.

The plurality of electrical wires 54 include an electrical wire 54A having high rigidity and an electrical wire 54B having lower rigidity than the electrical wire 54A. For example, the electrical wire 54A is a thick electrical wire such as a power source line, and the electrical wire 54B is a thin electrical wire such as a signal line. Herein, in the plurality of electrical wires 54 extending from the first harness connector 44X toward the apparatus connector 42, the electrical wires 54A are located on an innermost peripheral side in a portion where the plurality of electrical wires 54 are bended midway from the first band-like part 57 to the second band-like part 58. The same applies to the plurality of electrical wires 54 extending from the second harness connector 44Y toward the apparatus connector 42. Accordingly, the electrical wire 54A is disposed in both side edge portions in the second band-like part 58. Accordingly, the electrical wire 54A having high rigidity can be grasped in an operation of routing the second band-like part 58, and thus the second band-like part 58 can be easily routed. However, in the plurality of electrical wires 54 extending from the first harness connector 44X toward the apparatus connector 42, the electrical wire 54B may be located on an innermost peripheral side in a portion where the plurality of electrical wires 54 are bended midway from the first band-like part 57 to the second band-like part 58.

The connector 40 may be held by the base member 56. It is also applicable that the electrical wire 54 extends from an end portion of the base member 56, and the connector 40 is provided away from the base member 56.

### <Effect Etc.>

According to the wire harness 30 having the above configuration, the first counterpart wire harness 20X and the second counterpart wire harness 20Y are collectively connected to the apparatus 22 via the apparatus connector 42. Accordingly, the number of connectors 40 of the apparatus 22 can be reduced compared with a case where the first counterpart wire harness 20X and the second counterpart wire harness 20Y are individually connected to the apparatus 22, and the apparatus 22 to which the wire harness 30 is connected can be downsized. The first apparatus wiring 51X and the second apparatus wiring 51Y are held by the flat base member 56, thus the intermediate wiring part is flat, and the thickness of the wire harness 30 can be reduced.

The distance from the first harness connector 44X to the second harness connector 44Y is smaller than any of the distance from the apparatus connector 42 to the first harness connector 44X and the distance from the apparatus connector 42 to the second harness connector 44Y. Accordingly, the first harness connector 44X and the second harness connector 44Y can be disposed close to each other, and an operation of connecting the first counterpart wire harness 20X and the second counterpart wire harness 20Y to the wire harness 30 is easily performed. The first counterpart wire harness 20X and the second counterpart wire harness 20Y can be simply connected to a distant apparatus 22 via the wire harness 30.

The first apparatus wiring 51X extends from the one end portion of the first band-like part 57 toward the tip end portion of the second band-like part 58, and the second apparatus wiring 51Y extends from the other end portion of the first band-like part 57 toward the tip end portion of the second band-like part 58. Accordingly, the first counterpart wire harness 20X and the second counterpart wire harness 20Y extending from sides opposite to each other can be simply connected to the wire harness 30.

The wire harness 30 does not include the wiring connecting the first harness connector 44X and the second harness connector 44Y. Accordingly, the wire harness 30 does not connect the first counterpart wire harness 20X and the second counterpart wire harness 20Y, thus the wire harness 30 is simplified.

The length of each of the first apparatus wiring 51X and the second apparatus wiring 51Y is equal to or smaller than one meter. Accordingly, the wire harness 30 can connect the apparatus 22 and the counterpart wire harness 20 in a narrow area in the vehicle 10.

The arrangement area in the vehicle 10 is the rear part area, the first harness connector 44X is the connector for the floor harness 20D, and the second harness connector 44Y is the connector for the rear harness 20E. Accordingly, the floor harness 20D and the rear harness 20E are connected to the apparatus 22 via the wire harness 30 in the rear part area in the vehicle 10.

### Embodiment 2

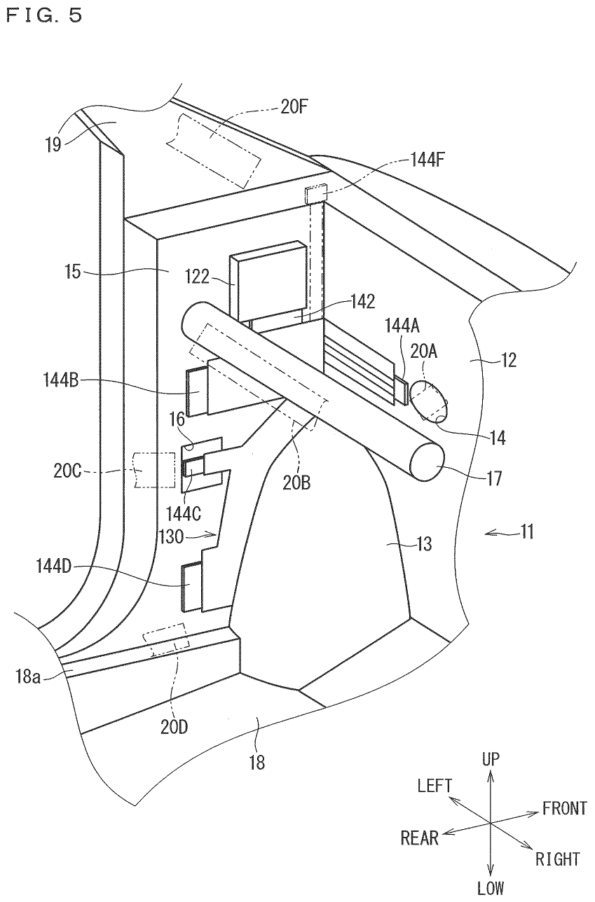

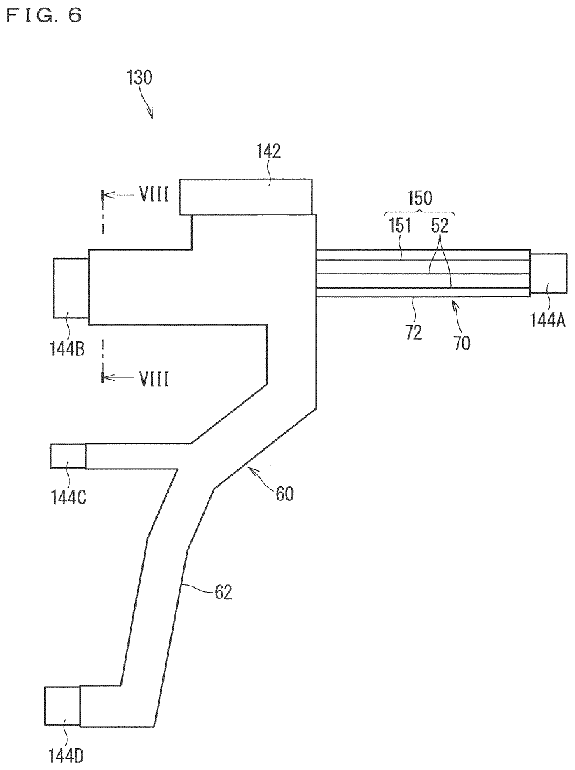

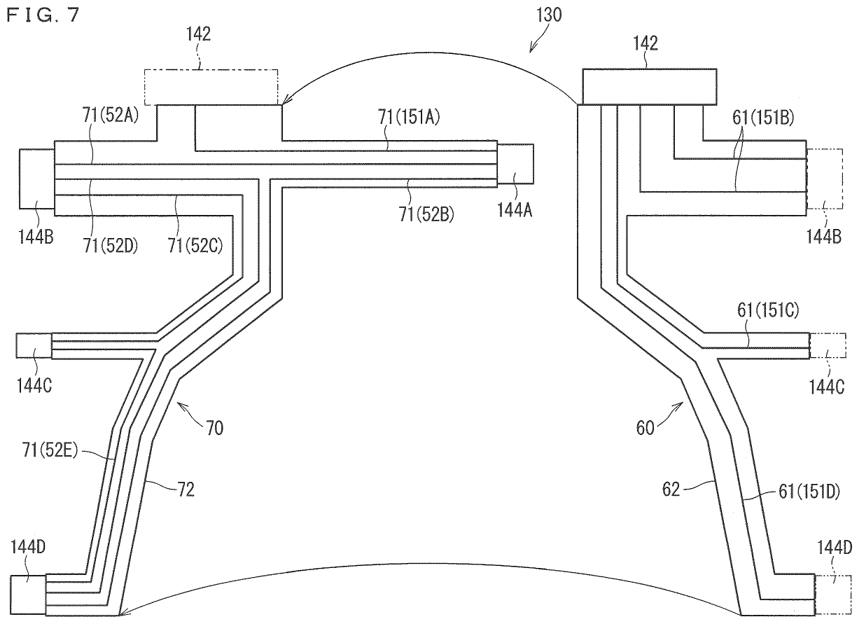

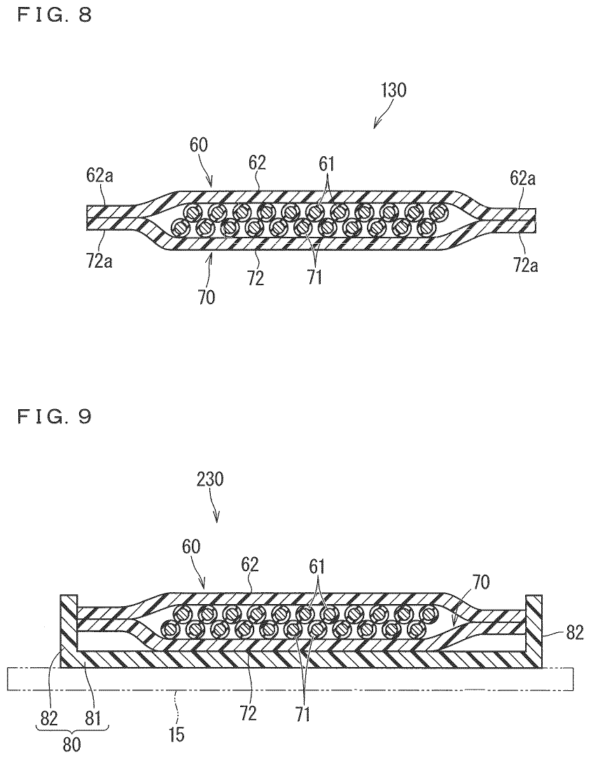

A wire harness 130 according to the embodiment 2 is described. FIG. 5 is a perspective view illustrating a state where the wire harness 130 according to the embodiment 2 is disposed in the vehicle 10. FIG. 6 is a plan view illustrating the wire harness 130 according to the embodiment 2. FIG. 7 is an exploded plan view illustrating the wire harness 130 according to the embodiment 2. FIG. 8 is a cross-sectional view along a VIII-VIII line in FIG. 6. In the following description of the present embodiment, the same reference numerals are assigned to the similar constituent elements described above, and the description thereof will be omitted.

The wire harness 130 connects the plurality of counterpart wire harnesses 20 to the apparatus 122. An arrangement area of the wire harness 130 is different from the arrangement area of the wire harness 30. The arrangement area of the wire harness 130 is closer to a front side than the arrangement area of the wire harness 30 in the vehicle 10. The arrangement area of the wire harness 130 is an area where a dashboard panel 11 and a cowl side panel 15 intersect with each other.

The dashboard panel 11 partitions an engine room and a vehicle interior in the vehicle 10. An area closer to the front side than the dashboard panel 11 is the engine room, and an area closer to a rear side than the dashboard panel 11 is the vehicle interior. An instrument panel is normally provided closer to the rear side than the dashboard panel 11, and the instrument panel is exposed to the vehicle interior. The dashboard panel 11 includes a body part 12 and a protrusion part 13. A main surface of the body part 12 of the dashboard panel 11 extends in the right-left direction and an up-down direction in the vehicle 10. The protrusion part 13 is provided on a lower side of an end portion of the body part 12 in the right-left direction. The protrusion part 13 a part protruding to a side of the vehicle interior from the body part 12. The protrusion part 13 is a part for providing a wheel house to the vehicle 10.

The cowl side panel 15 is continuously formed with the dashboard panel 11 in each of a left side and a right side of the dashboard panel 11. A main surface of the cowl side panel 15 extends in the front-back direction and the up-down direction in the vehicle 10. FIG. 1 illustrates an area where the cowl side panel 15 provided on the left side of the dashboard panel 11 and the dashboard panel 11 intersect with each other. An edge portion on a lower front side of the cowl side panel 15 is bended in accordance with the protrusion part 13.

An end portion of the instrument panel reinforcement 17 is fixed to the cowl side panel 15. The instrument panel reinforcement 17 is provided between the dashboard panel 11 and the instrument panel. The instrument panel reinforcement 17 is a rod-like member elongated in the right-left direction. The floor panel 18 is provided on a lower side of the area where the dashboard panel 11 and the cowl side panel 15 intersect with each other. A main surface of the floor panel 18 extends in the front-back direction and the right-left direction in the vehicle 10.

A combination of the plurality of counterpart wire harnesses 20 connected to the wire harness 130 is different from that of the plurality of counterpart wire harnesses 20 connected to the wire harness 30. Some of the counterpart wire harnesses 20 may be connected to both the wire harness 30 and the wire harness 130. The counterpart wire harness 20 connected to both the wire harness 30 and the wire harness 130 is not necessary.

Assumed as the counterpart wire harness 20 connected to the wire harness 130 are the engine room harness 20A, the instrument panel harness 20B, the door harness 20C, and the floor harness 20D, for example. The floor harness 20D is connected to both the wire harness 30 and the wire harness 130. The floor harness 20D is connected to the wire harness 130 on the front side of the area where the floor harness 20D itself is disposed, and is connected to the wire harness 30 on the back side of the area where the floor harness 20D itself is disposed. A roof harness 20F may be assumed as the counterpart wire harness 20 connected to the wire harness 130. The roof harness 20F is disposed in a roof.

The arrangement area of the wire harness 130 and the arrangement area of the engine room harness 20A are partitioned by the dashboard panel 11. Herein, a through hole 14 is formed in the dashboard panel 11. The wire harness 130 and the engine room harness 20A are connected through the through hole 14. In the similar manner, the arrangement area of the wire harness 130 and the arrangement area of the door harness 20C are partitioned by the cowl side panel 15. Herein, a through hole 16 is formed in the cowl side panel 15. The wire harness 130 and the door harness 20C are connected through the through hole 16. The roof is located on an upper side of the area where the dashboard panel 11 and the cowl side panel 15 intersect with each other. For example, an end portion of the roof harness 20F connected to the wire harness 130 extends from the roof to the area where the dashboard panel 11 the cowl side panel 15 intersect with each other or near the area along an A pillar 19.

The apparatus 122 is an apparatus provided separately from the apparatus 22. The apparatus 122 is disposed in the same area as the arrangement area of the wire harness 130. In the example illustrated in FIG. 1, the apparatus 122 is fixed to the cowl side panel 15. The apparatus 122 may be fixed to the dashboard panel 11, the instrument panel reinforcement 17, or the floor panel 18, for example.

The apparatus 122 is a zone ECU different from the apparatus 22. In this case, the apparatus 122 as the zone ECU controls a plurality of apparatuses as the connection destinations of the engine room harness 20A, the instrument panel harness 20B, the door harness 20C, and the floor harness 20D, for example. However, the apparatus 122 as the ECU may be a general ECU other than the zone ECU. The apparatus 122 needs not be the ECU, but may be a junction block (also referred to as an electrical junction box), for example.

The wire harness 130 includes an apparatus connector 142, plural types of harness connector 144, and a plurality of wirings 150. Provided herein as the plural types of harness connector 144 are an engine room harness connector 144A, an instrument panel harness connector 144B, a door harness connector 144C, and a floor harness connector 144D. The plurality of wirings 150 include a plurality of apparatus wirings 151 and a through circuit wiring 52. The apparatus wiring 151 connects the apparatus connector 142 and the harness connector 144. The through circuit wiring 52 connects the harness connectors 144.

As illustrated in FIG. 7, apparatus wirings 151A, 151B, 151C, and 151D are provided as the apparatus wiring 151 herein. The apparatus wiring 151A connects the engine room harness connector 144A and the apparatus connector 142. The apparatus wiring 151B connects the instrument panel harness connector 144B and the apparatus connector 142. The apparatus wiring 151C connects the door harness connector 144C and the apparatus connector 142. The apparatus wiring 151D connects the floor harness connector 144D and the apparatus connector 142. The number of each of the apparatus wirings 151A, 151B, 151C, and 151D may be one or more.

As illustrated in FIG. 7, through circuit wirings 52A, 52B, 52C, 52D, and 52E are provided herein as the through circuit wiring 52. The through circuit wiring 52A connects the engine room harness connector 144A and the instrument panel harness connector 144B. The through circuit wiring 52B connects the engine room harness connector 144A and the floor harness connector 144D. The through circuit wiring 52C connects the instrument panel harness connector 144B and the door harness connector 144C. The through circuit wiring 52D connects the instrument panel harness connector 144B and the floor harness connector 144D. The through circuit wiring 52E connects the door harness connector 144C and the floor harness connector 144D. The number of each of the through circuit wirings 52A, 52B, 52C, 52D, and 52E may be one or more.

Accordingly, the wiring 150 is provided to nine routes other than one route between the engine room harness connector 144A and the door harness connector 144C in ten routes of five types of connectors 142 and 144.

All of four types of harness connector 144 of the engine room harness connector 144A, the instrument panel harness connector 144B, the door harness connector 144C, and the floor harness connector 144D are connected to the apparatus connector 142 via the apparatus wiring 151. Six groups of connectors are generated as a combination selected two of four types of harness connector 144 of the engine room harness connector 144A, the instrument panel harness connector 144B, the door harness connector 144C, and the floor harness connector 144D. In any of six groups, one of the harness connectors 144 can be a first harness connector, and the other one of the harness connector 144 can be a second harness connector. Five of six groups except for one group made up of the engine room harness connector 144A and the door harness connector 144C include the through circuit wiring 52 connecting two types of harness connector 144 in each of five groups. In the meanwhile, the wire harness 130 does not include herein the through circuit wiring 52 connecting the engine room harness connector 144A and the door harness connector 144C.

Herein, the connectors in the wire harness 130 have five types, that is the apparatus connector 142, the engine room harness connector 144A, the instrument panel harness connector 144B, the door harness connector 144C, and the floor harness connector 144D. Thus, when each of the apparatus connector 142, the engine room harness connector 144A, the instrument panel harness connector 144B, the door harness connector 144C, and the floor harness connector 144D includes a plurality of split connectors, the number thereof is preferably three or less. For example, when each of four counterpart wire harnesses 20 of the engine room harness 20A, the instrument panel harness 20B, the door harness 20C, and the floor harness 20D is connected to the apparatus 122, four groups of connectors need to be fitted. In contrast, when the apparatus connector 142 is made up of three or less split connectors, the number of groups of the connectors to be fitted can be three or less.

The number of counterpart wire harnesses 20 connected to the wire harness 130 is larger than that of counterpart wire harnesses 20 connected to the wire harness 30. The number of wirings 150 of the wire harness 130 is larger than that of wirings 50 of the wire harness 30. As illustrated in FIG. 7, some of the plurality of wirings 150 are fixed to a base member 62, and collectively constitute a first wiring group 60. The other some of the plurality of wirings 150 are fixed to the base member 62, and collectively constitute a second wiring group 70. Needless to say, it is also applicable that the plurality of wirings 150 do not constitute the first wiring group 60 and the second wiring group 70, but are collected in a bundle.

A way of partitioning the plurality of wirings 150 into the first wiring group 60 and the second wiring group 70 is not particularly limited, but can be appropriately set. Herein, the plurality of wirings 150 are partitioned based on the apparatus wiring 151 and the through circuit wiring 52. Specifically, more than half of the first wiring group 60 are the apparatus wirings 151. More than half of the second wiring group 70 are the through circuit wirings 52. 60% or more, 70% or more, 80% or more, or 90% or more of the first wiring group 60 may be the apparatus wirings 151. All (100%) of the first wiring group 60 may be the apparatus wirings 151. In the similar manner, 60% or more, 70% or more, 80% or more, or 90% or more of the second wiring group 70 may be the through circuit wirings 52. All (100%) of the second wiring group 70 may be the through circuit wirings 52.

In the example illustrated in FIG. 7, all (100%) of the first wiring group 60 are the apparatus wirings 151. 90% or more of the second wiring group 70 are the through circuit wirings 52. Provided to the second wiring group 70 is the apparatus wiring 151A connecting the engine room harness connector 144A and the apparatus connector 142 in the apparatus wirings 151. The apparatus wirings 151B, 151C, and 151D except for the apparatus wiring 151A in the apparatus wiring 151 are provided to the first wiring group 60. All of the through circuit wirings 52 are provided to the second wiring group 70.

Each of the first wiring group 60 and the second wiring group 70 are flatly formed and stacked to each other. Herein, the first wiring group 60 includes a plurality of electrical wires 61 and a flat base member 62 to which the plurality of electrical wires 61 are fixed. The second wiring group 70 includes a plurality of electrical wires 71 and a flat base member 72 to which the plurality of electrical wires 71 are fixed.

In the first wiring group 60, the electrical wires 61 are disposed so as not to intersect with each other on the base member 62. Also in the second wiring group 70, the electrical wires 71 are disposed so as not to intersect with each other on the base member 72. Accordingly, increase of the thickness of each of the first wiring group 60 and the second wiring group 70 is suppressed, and increase of the thickness of the wire harness 130 in which the first wiring group 60 and the second wiring group 70 are stacked to each other is suppressed. However, in at least one of the first wiring group 60 and/or the second wiring group 70, an intersection part where the electrical wires intersect with each other on the base member may also be provided.

Herein, a part of the wire harness 130 is disposed along the dashboard panel 11. A wiring part extending from the engine room harness connector 144A is held to be disposed along the dashboard panel 11.

The other part of the wire harness 130 is disposed along the cowl side panel 15. The instrument panel harness connector 144B, the door harness connector 144C, and the floor harness connector 144D are held so that they are arranged in a height direction and a wiring part extending from each of the instrument panel harness connector 144B, the door harness connector 144C, and the floor harness connector 144D is disposed along the cowl side panel 15. When the roof harness 20F is assumed as the counterpart wire harness 20, a roof harness connector 144F is provided as one type of the plural types of harness connectors 144. The roof harness connector 144F may be provided on an upper side of the apparatus connector 142, the engine room harness connector 144A, the instrument panel harness connector 144B, the door harness connector 144C, and the floor harness connector 144D in the vehicle, for example. The wiring connected to the roof harness connector 144F may extend in the up-down direction on a lateral side of the apparatus 122.

In the wire harness 130, the electrical wire 71 and the base member 72 are disposed in a bended state in the thickness direction between a portion disposed along the dashboard panel 11 and a portion disposed along the cowl side panel 15. Herein, the portion disposed along the dashboard panel 11 is only the second wiring group 70 in the first wiring group 60 and the second wiring group 70. Thus, the wire harness 130 is easily bended in the thickness direction between the portion disposed along the dashboard panel 11 and the portion disposed along the cowl side panel 15.

The base members 62 and 72 include a route bending part in the portion disposed along the cowl side panel 15. The route bending part is formed into a bending shape along a protrusion part 13. The electrical wires 61 and 71 are disposed along the route bending part, thus are easily disposed along the protrusion part 13. For example, the wiring 150 extending toward the door harness connector 144C and the wiring 150 extending toward the floor harness connector 144D are disposed along the route bending part. A branch part is provided in a midway part of the route bending part in the base members 62 and 72. The wiring 150 extending toward the door harness connector 144C and the wiring 150 extending toward the floor harness connector 144D are branched at the branch part.

The first wiring group 60 and the second wiring group 70 are stacked so that a main surface of the base member 62 to which the electrical wire 61 and a main surface of the base member 62 to which the electrical wire 71 is fixed face each other. Accordingly, the electrical wires 61 and 71 are surrounded and protected by the base members 62 and 72. However, it is also applicable that the first wiring group 60 and the second wiring group 70 are stacked so that a main surface of the base member 62 to which the electrical wire 61 is fixed and a main surface of the base member 72 to which the electrical wire 71 is not fixed face each other, or are stacked so that a main surface of the base member 72 to which the electrical wire 71 is fixed and a main surface of the base member 62 to which the electrical wire 61 is not fixed face each other. The first wiring group 60 and the second wiring group 70 may be stacked so that a main surface of the base member 62 to which the electrical wire 61 is not fixed and a main surface of the base member 72 to which the electrical wire 71 is not fixed face each other.

The base member 62 includes an extension piece 62a. The extension piece 62a is provided on both sides of a portion where the electrical wire 61 is disposed. The base member 72 also includes an extension piece 72a similar to the extension piece 62a. When the extension piece 62a of the base member 62 and the extension piece 72a of the base member 72 are fixed to each other, the first wiring group 60 and the second wiring group 70 are fixed to each other. However, the extension piece 62a of the base member 62 and the extension piece 72a of the base member 72 need not be fixed to each other.

A length of each of the plurality of wirings 150 is equal to or smaller than one meter. In the wire harness 130, the longest wiring 150 is the through circuit wiring 52B connecting the engine room harness connector 144A and the floor harness connector 144D or the through circuit wiring 52C connecting the instrument panel harness connector 144B and the floor harness connector 144D. A length of each of these through circuit wirings 52B and 52C is equal to or smaller than one meter.

Also according to the wire harness 130 having the above configuration, an effect similar to the wire harness 30 can be obtained except for an effect depending on a difference of the arrangement area. According to the wire harness 130, the plurality of counterpart wire harnesses 20 can be connected to the apparatus 122 in the area where the dashboard panel 11 and the cowl side panel 15 intersect with each other.

### Modification Example

A modification example of the wire harnesses 30 and 130 is described. Described hereinafter is a specific description as an example of the modification example of the wire harness 130, and the modification example can also be applied to the wire harness 30.

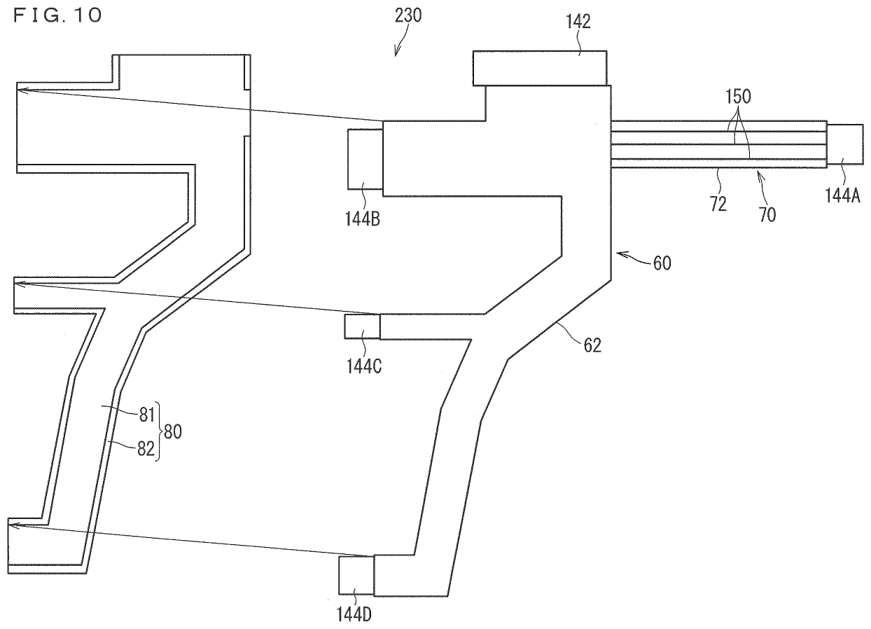

FIG. 9 is a cross-sectional view illustrating a wire harness 230 according to a first modification example. FIG. 10 is an exploded cross-sectional view illustrating the wire harness 230 according to the first modification example.

The wire harness 230 according to the first modification example is different from the wire harness 130 described above in that the wire harness 230 further includes a rigid member 80. The rigid member 80 has higher rigidity than the sheet member. The rigid member 80 can keep a wiring form of the first wiring group 60 and the second wiring group 70 more firmly than the sheet member. Accordingly, the rigid member 80 is disposed in the vehicle 10, thus the wiring 150 can be easily disposed along a predetermined route. The rigid member 80 may be formed by metal or rigid resin, for example.

A position where the rigid member 80 is provided in the wire harness 230 is not particularly limited, but can be appropriately set. Herein, the rigid member 80 is provided in a part of the wire harness 230 disposed along the cowl side panel 15. The rigid member 80 is not provided to a part of the wire harness 230 disposed along the dashboard panel 11.

The rigid member 80 is provided to cover a whole part of the wire harness 230 disposed along the cowl side panel 15. The rigid member 80 may be provided to cover a part of the wire harness 230 disposed along the cowl side panel 15. For example, the rigid member 80 may be provided to cover a part located on an upper side along a vertical direction (herein, a part extending from the instrument panel harness connector 144B and a part extending from the apparatus connector 142).

The rigid member 80 may be disposed between the wire harness 230 and the cowl side panel 15. The wire harness 230 may be disposed between the rigid member 80 and the cowl side panel 15.

A shape of the rigid member 80 is not particularly limited, but can be appropriately set. Herein, the rigid member 80 has a bucket shape including a bottom part 81 and a sidewall 82. The first wiring group 60 and the second wiring group 70 are housed in a housing part surrounded by the bottom part 81 and the sidewall 82. The rigid member 80 may include a cover covering an opening of the housing part. It is also applicable that the rigid member 80 does not include the sidewall 82 but includes the bottom part 81.

It is also applicable that the wire harness 130 does not include the flexible sheet member as the base member but includes the rigid member 80 as the base member in place of the sheet member. In the rigid member 80, a partition wall may be provided between a pair of sidewalls 82. Accordingly, a plurality of housing parts are provided to the rigid member. It is applicable in this case that some of the plurality of wirings are housed in a first housing part to constitute a first wiring group and the other some of the plurality of wirings are housed in a second housing part to constitute a second wiring group. For example, the apparatus wiring 151 and the through circuit wiring 52 may be separately housed in the plurality of housing parts. For example, a power source line 461 and a signal line 471 may be separately housed in the plurality of housing parts.

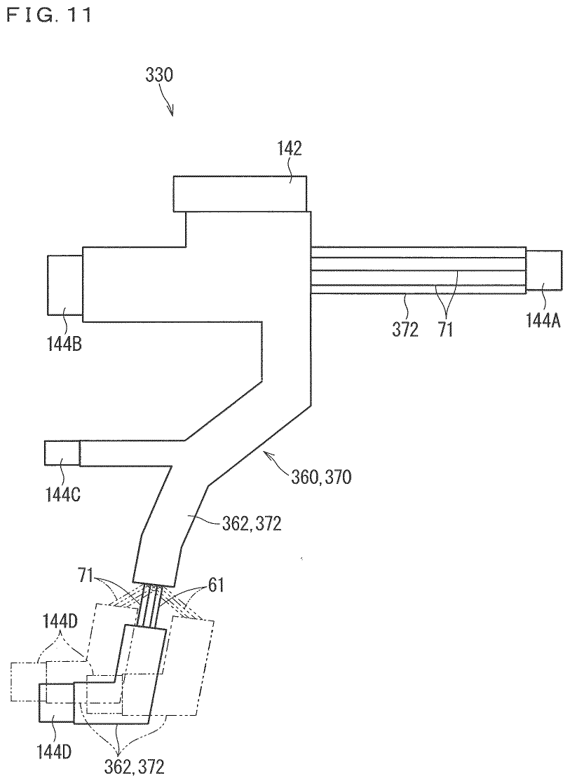

FIG. 11 is a plan view illustrating a wire harness 330 according to the second modification example.

Positions where base members 362 and 372 are provided in the wire harness 330 according to the second modification example are different from positions where the base members 62 and 72 are provided in the wire harness 130 described above. Specifically, the plurality of base members 362 and 372 are provided at intervals along an extension direction of the plurality of electrical wires 71 and 61 in positions corresponding to the first wiring group 360 and the second wiring group 370, respectively. Accordingly, the plurality of electrical wires 71 and 61 are easily bended in the portion between the plurality of base members 362 and 372 compared with the portion where the plurality of base members 362 and 372 are provided, and a difference of route or redundant length can be easily absorbed. Accordingly, the common wire harness 330 can be easily applied to vehicle having different sizes.

Herein, a section where the base members 356 and 362 are disconnected in an intermediate portion of the wiring 150 along an extension direction thereof is provided to a part of the wire harness 330 disposed along the cowl side panel 15 and extending a vertical direction. In this case, the wire harness 330 is easily applied to plural types of vehicle each having a height dimension different from each other. In this case, the wire harness 330 is formed in accordance with a vehicle having a large height. When the wire harness 330 is applied to a vehicle having a small height, the electrical wires 71 and 61 are bended in a section where the base members 362 and 372 are disconnected, and a redundant length is absorbed. For example, the section where the base members 362 and 372 are disconnected may be provided between the door harness connector 144C and the floor harness connector 144D.

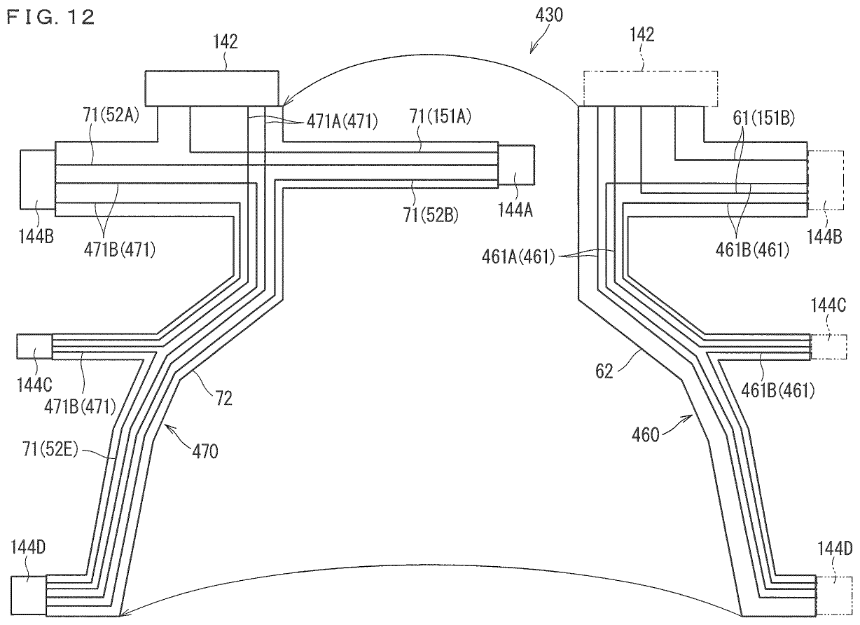

FIG. 12 is an exploded plan view illustrating a wire harness 430 according to a third modification example.

A configuration of dividing the wirings into a first wiring group 460 and a second wiring group 470 in the wire harness 430 according to the third modification example is different from a configuration of dividing the wirings into the first wiring group 60 and the second wiring group 70 in the wire harness 130 described above. Herein, the wirings 150 are divided into the first wiring group 460 and the second wiring group 470 based on whether the wirings 150 are the power source lines 461 or the signal lines 471. Specifically, more than half of the second wiring group 470 are the signal lines 471. A ratio of the power source lines 461 in the first wiring group 460 is higher than that of the power source lines in the second wiring group 470. Accordingly, most of the power source lines 461 and most of the signal lines 471 can be separated.

The ratio of the power source line 461 in the first wiring group 460 is not particularly limited, but can be appropriately set. For example, the ratio of the power source line 461 in the first wiring group 460 may be equal to or larger than 50% or smaller than 50%. That is to say, more than half of the first wiring group 460 may be the power source lines 461 or signal lines.

More than half of all the power source lines in the wire harness 430 may be disposed in the first wiring group 460. More than half of all the signal lines in the wire harness 430 may be disposed in the second wiring group 470. The first wiring group 460 may or may not include the signal line. The second wiring group 470 may or may not include the power source line.

In the example illustrated in FIG. 12, the power source line 461 in the wirings 150 connected to the door harness connector 144C and the wirings 150 connected to the floor harness connector 144D is provided in the first wiring group 460, and the signal line 471 is provided in the second wiring group 470. A power source line 461A in the first wiring group 460 connects each of the door harness connector 144C and the floor harness connector 144D to the apparatus connector 142. A power source line 461B in the first wiring group 460 connects each of the door harness connector 144C and the floor harness connector 144D to the other harness connector 144. A signal line 471A in the second wiring group 470 connects each of the door harness connector 144C and the floor harness connector 144D to the apparatus connector 142. A signal line 471B in the second wiring group 470 connects each of the door harness connector 144C and the floor harness connector 144D to the other harness connector 144.

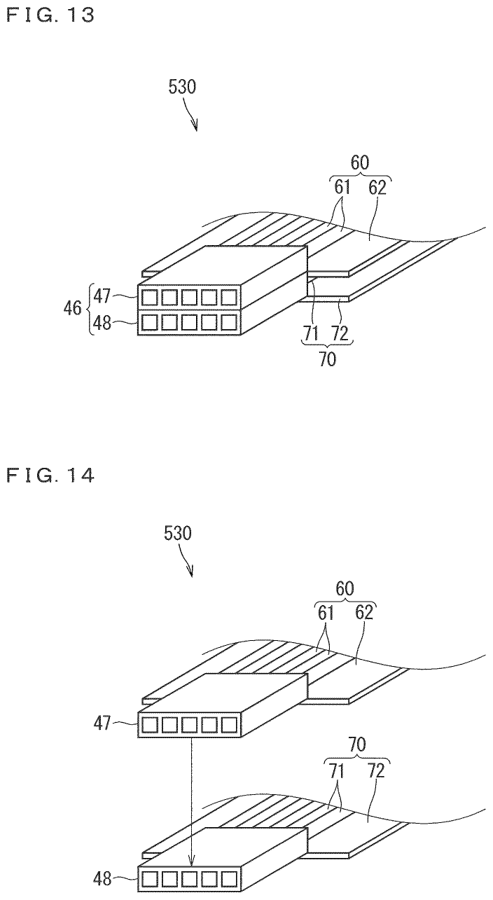

FIG. 13 is a perspective view illustrating a wire harness 530 according to a fourth modification example. FIG. 14 is an exploded perspective view illustrating the wire harness 530 according to the fourth modification example.

A shape of a connector 46 in the wire harness 530 according to the fourth modification example is different from the shape of the connector 40 in the wire harness 130 described above. Specifically, at least one type of connector 46 in the plural types of connector 40 is made up of a plurality of split connectors 47 and 48. The plurality of split connectors 47 and 48 include a first split connector 47 and a second split connector 48. The wiring 150 of the first wiring group 60 is connected to the first split connector 47. The wiring of the second wiring group 70 is connected to the second split connector 48. Accordingly, an operation of inserting one of the wiring 150 of the first wiring group 60 and the wiring 150 of the second wiring group 70 into the connector 40 into which the other one of wiring 150 of the first wiring group 60 and the wiring 150 of the second wiring group 70 is previously inserted hardly occurs compared with the case of the wire harness 130. Accordingly, it is easy to separately manufacture the first wiring group 60 and the second wiring group 70 and subsequently integrate them to constitute the wire harness 530.

Herein, the first split connector 47 and the second split connector 48 are integrated to constitute a stacked connector 46. Accordingly, at least one type of connector 46 in the plural types of connector 40 is the stacked connector 46 made up of the plurality of split connectors 47 and 48 integrated with each other. Each type of connector 40 may be divided in a form other than the stacked connector 46. For example, the apparatus connector 142 may be divided into a plurality of split connectors arranged in a direction intersecting with the thickness direction. It is also applicable that two split connectors are not integrated but are connected to the apparatus 122.

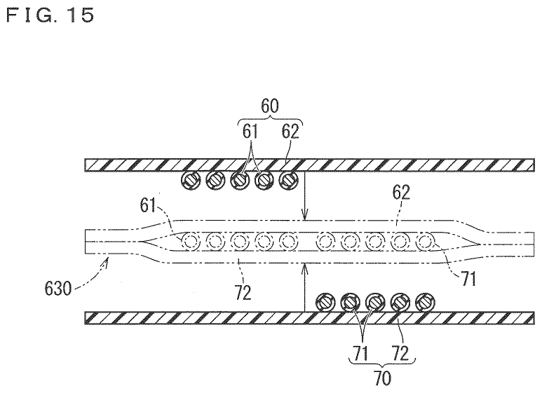

FIG. 15 is a cross-sectional view illustrating a wire harness 630 according to a fifth modification example.

A stacked form of the first wiring group 60 and the second wiring group 70 in the wire harness 630 according to the fifth modification example is different from the stacked form of the wire harness 130 described above. The wiring 150 of the first wiring group 60 and the wiring 150 of the second wiring group 70 are disposed to deviate in a parallel direction so as not to be stacked to each other in the portion where the first wiring group 60 and the second wiring group 70 are stacked to each other. Accordingly, a thickness of the wire harness 630 in which the first wiring group 60 and the second wiring group 70 are stacked is reduced compared with the case where the wiring 150 of the first wiring group 60 and the wiring 150 of the second wiring group 70 are stacked to each other. Multilayer configuration of the wiring 150 is suppressed, thus the wire harness 630 is easily bended in the thickness direction. The stacked form may be provided in a part of the wire harness 630, or may also be provided to the whole wire harness 630. For example, the stacked form may be provided in a part of the wire harness 630 extending from the door harness connector 144C.

Moreover, at least some of the plural types of connector 40 may be standby connectors. For example, at least some of the plurality of harness connectors 44 may be standby connectors. Accordingly, the counterpart wire harness can be easily connected to the harness connector 44.

The configurations described in the embodiments and modification examples thereof can be appropriately combined as long as they are not contradictory.

### EXPLANATION OF REFERENCE SIGNS

10 vehicle
11 dashboard panel
12 body part
13 protrusion part
14 through hole
15 cowl side panel
16 through hole
17 instrument panel reinforcement
18 floor panel
18a rocker part
19 A pillar
20 counterpart wire harness
20A engine room harness
20B instrument panel harness
20C door harness
20D floor harness
20E rear harness
20F roof harness
20X first counterpart wire harness
20Y second counterpart wire harness
22, 122 apparatus
30, 130, 230, 330, 430, 530, 630 wire harness
40 connector
42, 142 apparatus connector
44, 144 harness connector
144A engine room harness connector
144B instrument panel harness connector
144C door harness connector
144D floor harness connector
144F roof harness connector
44X first harness connector (floor harness connector)
44Y second harness connector (rear harness connector)
46 stacked connector
47 first split connector
48 second split connector
50, 150 wiring
51, 151, 151A, 151B, 151C, 151D apparatus wiring
51X first apparatus wiring
51Y second apparatus wiring
52, 52A, 52B, 52C, 52D, 52E through circuit wiring
54, 54A, 54B electrical wire
55a core wire
55b covering layer
56 base member
57 first band-like part
58 second band-like part
60, 360, 460 first wiring group
61 electrical wire
461, 461A, 461B power source line
62, 362 base member
62a extension piece
70, 370 second wiring group
71 electrical wire
471, 471A, 471B signal line
72, 372 base member
72a extension piece
80 rigid member
81 bottom part
82 sidewall
100 wiring system

1. A wire harness, comprising:
an apparatus connector connected to a connector of an apparatus;
a first harness connector connected to a connector of a first counterpart wire harness;
a second harness connector connected to a connector of a second counterpart wire harness;
a first apparatus wiring connecting the apparatus connector and the first harness connector;
a second apparatus wiring connecting the apparatus connector and the second harness connector; and
a flat base member holding the first apparatus wiring and the second apparatus wiring.

2. The wire harness according to claim 1, wherein
a distance from the first harness connector to the second harness connector is smaller than any of a distance from the apparatus connector to the first harness connector and a distance from the apparatus connector to the second harness connector.

3. The wire harness according to claim 2, wherein
the base member includes a first band-like part and a second band-like part having a larger length than the first band-like part,
a base end portion of the second band-like part extends from an intermediate portion of the first band-like part in a direction intersecting with the first band-like part,
the first harness connector is provided to one end portion of the first band-like part, the second harness connector is provided to another end portion of the first band-like part, and the apparatus connector is provided to a tip end portion of the second band-like part,
the first apparatus wiring extends from the one end portion of the first band-like part toward the tip end portion of the second band-like part, and
the second apparatus wiring extends from the another end portion of the first band-like part toward the tip end portion of the second band-like part.

4. The wire harness according to claim 1, wherein
a wiring connecting the first harness connector and the second harness connector is not included.

5. The wire harness according to claim 1, wherein
a length of each of the first apparatus wiring and the second apparatus wiring is equal to or smaller than one meter.

6. The wire harness according to claim 1, wherein
an arrangement area in a vehicle is a rear part area,
the first harness connector is a floor harness connector, and
the second harness connector is a rear harness connector.
